(19) United States
(12) Patent Application Publication
(10) Pub. No.: US 2014/0374026 A1
(43) Pub. Date: Dec. 25, 2014

(54) THREE DRUM TIRE-FORMING MACHINE AND MATERIAL-CONVEYING METHOD THEREFOR

(71) Applicant: MESNAC CO., LTD., Shandong (CN)

(72) Inventors: Zhongxue Yuan, Shandong (CN); Jiguo Cheng, Shandong (CN); Xiaowei Xiong, Shandong (CN); Wei Huang, Shandong (CN); Xuefeng Peng, Shandong (CN)

(73) Assignee: MESNAC CO., LTD., Shandong (CN)

(21) Appl. No.: 14/354,954

(22) PCT Filed: Dec. 7, 2012
(86) PCT No.: PCT/CN2012/086138

§ 371 Date: Aug. 26, 2014

(30) Foreign Application Priority Data
Dec. 7, 2011 (CN) 201110402784.7

(51) Int. Cl. B29D 30/24; B29D 30/00

(52) U.S. Cl. CPC B29D 30/24; B29D 30/005; B29D 2030/202
USPC 156/396

(57) ABSTRACT

The triple-drum forming machine for the tire comprises a tire body drum, a belted layer drum and a forming drum, which are arranged on the same horizontal axis, wherein a portal frame for conveying a raw material is vertically arranged above the tire body drum, the belted layer drum and the forming drum; the transverse central line of the portal frame overlaps with the axial center lines of the tire body drum, the belted layer drum and the forming drum; the tops of the tire body transfer ring component and the belted layer transfer ring are respectively connected to the portal frame in a sliding manner; the portal frame comprises a horizontally arranged truss and a plurality of groups of vertically arranged upright posts; the horizontally arranged truss is connected with the vertically arranged upright posts.

The present invention claims priority under 35 U.S.C. §119 to Application No. PCT/CN2012/086138 filed Dec. 7, 2012, which claims priority to Chinese Patent Application No. 2011-10402784.7, filed Dec. 7, 2011, both of which are incorporated herein in their entirety.

### FIELD OF THE INVENTION

The invention relates to a triple-drum forming machine for a tire billet and a material conveying method thereof, and belongs to the field of rubber machinery.

### BACKGROUND OF THE INVENTION

Rubber tires used by spacecrafts, military vehicles, and some civilian vehicles, for example, are mainly composed of a steel wire tire bead, a tire body component, and a belted layer-tread component.

Two-drum, triple-drum and four-drum forming machines are usually used in the existing tire billet manufacturing device and method for these types of tires. The difference in tire billet production technologies is determined by differences in the manufacturing equipment and method. These present manufacturing equipment and methods have certain defects, and thus, cannot completely achieve the requirements of the tire forming quality and production efficiency.

For example, application number ZL200710016571.4, entitled “triple-drum forming machine for the tire billet and the method thereof” discloses a tire body drum, a belted layer drum and a forming drum of the forming machine are arranged on the same horizontal axis; the tire body drum is carried by a tire body drum drive unit; the belted layer drum and the forming drum are carried by a same forming drum drive unit; the forming drum drive unit and the tire body drum drive unit are oppositely and coaxially arranged on the same bottom guide rail; a tire body transfer ring component for conveying a prepared tire body component to the forming drum is connected to the bottom guide rail in a sliding manner between the tire body drum and the forming drum; the belted layer transfer ring for conveying a prepared belted layer-tread component to the forming drum is connected to the bottom guide rail between the tire body drum and the forming drum.

The tire body transfer ring component and the belted layer transfer ring carry out reciprocating sliding to convey kinds of materials along the bottom guide rail in an equipment device for manufacturing the tire, many parts of the tire forming machine are arranged on the ground as a whole and occupy large land surface area. Therefore, an operator always shuttles back and forth between the various mobile components in the tire billet manufacturing process, so as to easily generate collision of the operator and the equipment, resulting in a potential safety hazard.

The equipment arranged on the ground involves an intricate network of pipelines. Thus, it is difficult to penetrate into the internal part of the equipment structure when the operator installs, debugs and inspects the overall machine. These operation difficulties are large, and time and labor are wasted.

In addition, the tire body transfer ring component and the belted layer transfer ring are arranged on the same bottom guide rail to convey the materials in a reciprocating manner. Thus, the demands that the guide rail and the ground be flat are high; the manufacturing operation accuracy of the overall tire billet is directly affected once the guide rail inclines or horizontally misplaces.

### INVENTION CONTENT

The triple-drum forming machine for the tire and the material conveying method thereof disclosed herein solves the defects and disadvantages of the above problems. An overhead portal frame structure is adopted in the preparation and conveying processes of a tire body component and a belted layer-tread component, namely a tire body transfer ring component and a belted layer transfer ring are conveyed in a sliding manner along a top portal frame to finish an air operation of all materials, so as to clear related ground conveyers, further reducing the occupied space of the forming machine and simplifying the structures of the ground parts. Thus, control and auxiliary operations of an operator in a tire billet manufacturing process are facilitated, and accidents caused by collision of the operator and equipment are avoided.

Another advantage of the invention is that pipeline pavement of the ground equipment is simplified, and installing, debugging and inspection of the overall forming machine by the operator are facilitated.

Moreover, as disclosed herein, coaxial lifting of all devices of the forming machine is achieved by improving the accuracy of a conveying track of the tire body transfer ring component and the belted layer transfer ring, so as to effectively improve the tire billet manufacturing quality.

Additional features and advantages of the invention will be set forth in the description that follows, and in part will be apparent from the description or may be learned by practice of the invention. The objectives and other advantages of the invention will be realized and attained by the structure particularly pointed out in the written description and claims hereof as well as the appended drawings.

To achieve these and other advantages and in accordance with the purpose of the invention, as embodied and broadly described, the present invention provides: a triple-drum forming machine for a tire, comprising: a tire body drum, a belted layer drum, and a forming drum, each of which is arranged on the same horizontal axis, wherein the tire body drum is carried by a tire body drum drive unit, the belted layer drum and the forming drum are carried by a same forming drum drive unit; a tire body transferring component for conveying a prepared tire body component to the forming drum arranged between the tire body drum and the forming drum; and a belted layer transfer ring for conveying a prepared belted layer-tread component to the forming drum arranged between the tire body drum and the belted layer drum, wherein a portal frame for conveying a dry material is arranged above vertical directions of the tire body drum, the belted layer drum and the forming drum; a transverse central line of the portal frame overlaps with axial center lines of the tire body drum, the belted layer drum and the forming drum; tops of the tire body transfer ring component and the belted layer transfer ring are respectively connected to the portal frame in a sliding manner; and the portal frame comprises a horizontally arranged truss and a plurality of groups of vertically arranged upright posts; the horizontally arranged truss being connected with the vertically arranged upright posts.

In another embodiment, ring bases are respectively arranged at the tops of the tire body transfer ring component and the belted layer transfer ring; a drive motor, which is connected to or controlled by the tire body drive unit or the forming drum drive unit is arranged on each ring base; and an output shaft of each drive motor is connected with a gear meshed with a rack on the portal frame.

Another described embodiment is slideways arranged at two sides of the portal frame; the ring bases are connected with a pair of slide saddles; and slide blocks arranged on the slide saddles are meshed with the slideways.

In another embodiment, a plurality of groups of adjusting frames for adjusting the horizontal distances between the truss and the upright posts, being arranged between vertical directions of the truss and the upright posts, wherein the adjusting frames are arranged inside slide chutes at the tops of the upright posts, and upwardly connected to the truss; and vertical brackets arranged on the upright posts, wherein inner thread holds are formed on the vertical brackets and connected with horizontal adjusting bolts, the horizontal adjusting bolts being connected to the adjusting frames.

In yet another embodiment, wedge liner components upwardly screwed on the truss are arranged on the adjusting frames into a fixation slot; wherein each wedge liner component comprises an upper wedge liner and a lower wedge liner, which are vertically laminated; inner thread holes are formed inside the fixation slot and connected with vertical adjusting bolts, the vertical adjusting bolts being connected with each upper wedge liner or each lower wedge liner.

Another embodiment comprises a light ruler arranged at the side part of the portal frame.

Another embodiment is a material conveying method achieved by a triple-drum forming machine, comprising: arranging the portal frame above the vertical directions of the tire body transfer ring component and the belted layer transfer ring to provide a sliding conveying path along two sides of the axial center lines of the tire body drum, the belted layer drum and the forming drum; transversely sliding the tire body transfer ring component along the portal frame to clamp and convey the tire body component to the forming drum in the process of conveying the tire body component to the forming drum; transversely sliding the belted layer transfer ring along the portal frame to convey the material for forming the belted layer-tread component to the belted layer drum and prepare the tread component in the process of preparing the belted layer-tread component; transversely sliding the belted layer transfer ring to the belted layer drum along the portal frame, clamping the tread component and conveying to the forming drum in the process of conveying the belted layer-tread component to the forming drum, wherein preparing the tire body component and conveying the tire body component to the forming drum and preparing the belted layer-tread component and conveying to the belted layer-tread component to the forming drum are simultaneously carried out; and transversely sliding the belted layer transfer ring to the forming drum along the portal frame to clamp the formed tire billet and convey the tire billet to a tire unloading mechanism after the sizing and pressing operations of the tread component and a tire body barrel are finished on the forming drum in the process of finishing tire billet manufacturing on the forming drum.

In another embodiment, the tire body transfer ring component and the belted layer transfer ring drive transmission between the gear and the rack on the portal frame by virtue of the drive motor to achieve transverse sliding of the tire body transfer ring component and the belted layer transfer ring along the portal frame, so as to finish material conveying.

In yet another embodiment, the tops of the tire body transfer ring component and the belted layer transfer ring provide sliding guide through the slide saddles meshed with the slideways at two sides of the portal frame in the transversely sliding along the portal frame.

Another embodiment discloses that the adjusting frames are driven to carry out longitudinal displacement through the horizontal adjusting bolts, so as to adjust the position of the transverse center line of the truss between the vertical directions of the truss and the upright posts; and the upper wedge liners and the lower wedge liners are driven to carry out longitudinal displacement through the vertical adjusting bolts, so as to adjust the vertical height of each end point of the truss.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a structure layout of the triple-drum forming machine for a tire according to a first embodiment of the present invention;

FIG. 2 is a main machine part sketch map of the forming machine according to a second embodiment of the present invention;

FIG. 3 is the sketch map of the portal frame according to a third embodiment of the present invention;

FIG. 4 is the structure sketch map of the truncated main machine part of the forming machine according to a fourth embodiment of the present invention;

FIG. 5 is the structure sketch map of the portal frame part from which the truss is removed according to a fifth embodiment of the present invention;

FIG. 6 is the structure sketch map of the part in FIG. 5 from which the wedge liner components are removed.

### DETAILED DESCRIPTION OF THE PREFERRED EMBODIMENTS

Reference will now be made in detail to the preferred embodiments of the present invention, examples of which are illustrated in the accompanying drawings.

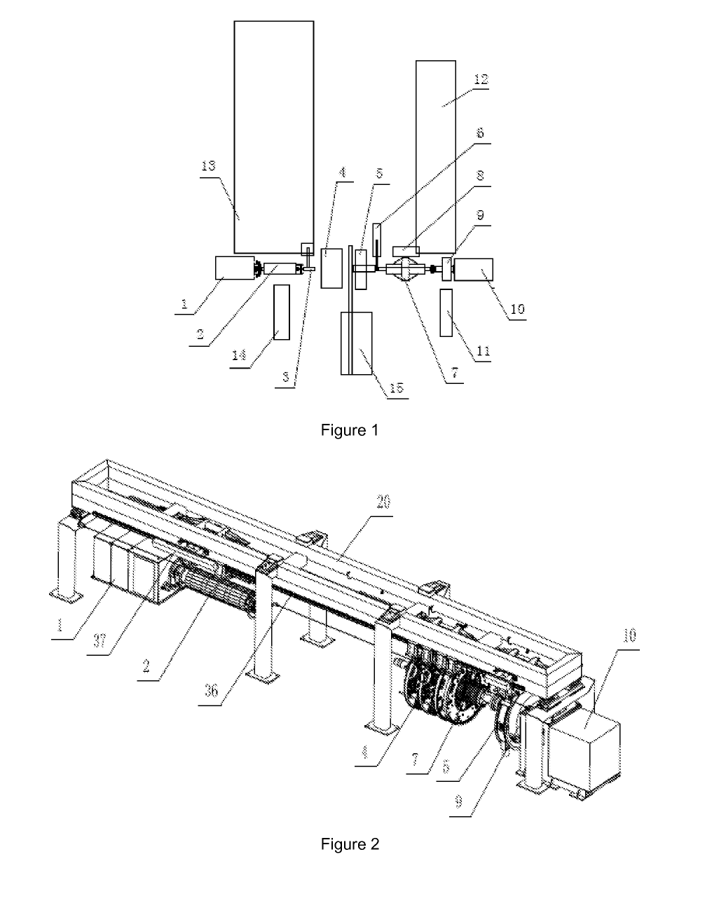

FIGS. 1-6, preferred embodiments of the present invention comprise at least a tire body drum drive unit 1, a tire body drum 2, a tire body drum tailstock 3, a tire body transfer ring component 4, a belted layer transfer ring 5, a forming drum tailstock 6, a forming drum 7, a combined roller 8, a belted layer drum 9, a forming drum drive unit 10, a tread feeding frame 11, a belted layer feeding frame 12, a main feeding frame 13, a pad rubber feeding frame 14, a tire unloading mechanism 15; a portal frame 20, a truss 21, upright posts 22, adjusting frames 23, slide chutes 24, vertical brackets 25, horizontal adjusting bolts 26, wedge liner components 27, a fixation slot 28, vertical adjusting bolts 29; ring bases 30, drive motors 31, frames 32, gears 33, slide saddles 34, slide blocks 35, slideways 36, a light ruler 37, upper wedge liners (271), and lower wedge liners (272).

As shown in FIGS. 1-6, the triple-drum forming machine for the tire mainly comprises a tire body drum 2, a belted layer drum 9, and a forming drum 7, all of which are arranged on the same horizontal axis.

A feeding system of the tire body drum 2 comprises the main feeding frame 13 and the pad rubber feeding frame 14 arranged at two sides of the tire body drum 2.

The feeding system of the belted layer drum 9 comprises the tread feeding frame 11 and the belted layer feeding frame 12 arranged at two sides of the belted layer drum 9.

The drive unit of the tire body drum 2 is the tire body drum drive unit 1, which is coaxially arranged on the outer side of the tire body drum 2.

The forming drum 7 and the belted layer drum 9 are carried by the same forming drum drive unit 10 arranged at the outer side of the belted layer drum 9.

The tire body drum drive unit 1 and the forming drum drive unit 10 are oppositely and coaxially arranged.

The tire body transfer component 4 for conveying the prepared tire body component to the forming drum 7 is arranged between the tire body drum 2 and the forming drum 7. The tire body transfer component 4 is used for clamping and conveying the tire body component. The tire body transfer component 4 comprises a steel rim clamping ring for clamping a steel rim, a tire body clamping ring and a tire side expansion ring.

The belted layer transfer ring 5 for conveying the prepared belted layer-tread component to the forming drum 7 is arranged at one side of the forming drum 7. The belted layer transfer ring 5 is arranged between the tire body drum 2 and the belted layer drum 9.

Based on the main machine structure of the forming machine as shown in FIG. 2, the portal frame 20 for conveying materials is arranged above the vertical directions of the tire body drum 2, the tire body drum layer 9 and the forming drum 7.

The transverse center line of the portal frame 20 overlaps with the axial center lines of the tire body drum 2, the tire body drum layer 9 and the forming drum 7.

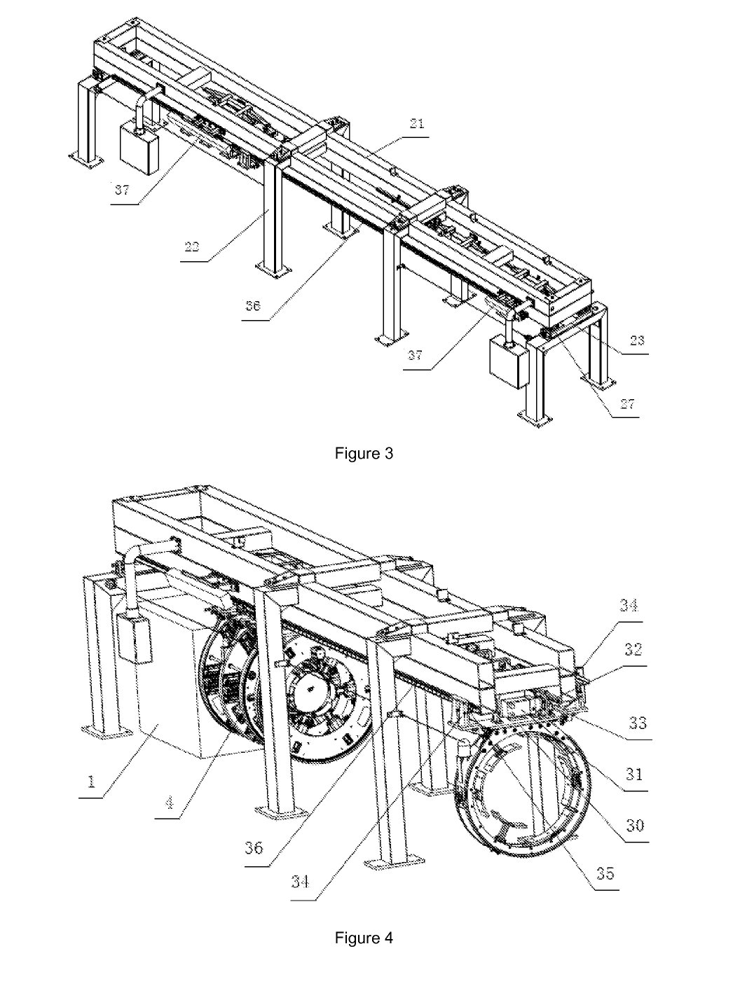

As shown in FIG. 3, portal frame 20 comprises the horizontally arranged truss 21 and a plurality of groups of vertically installed upright posts 22; the truss 21 and the upright posts 22 are connected with each other.

As shown in FIG. 4, ring bases 30 are respectively arranged at the tops of the tire body transfer ring component 4 and the belted layer transfer ring 5. The drive motors 31, which are connected to and controlled by the tire body drum drive unit 1 or the forming drum drive unit 10, are arranged on the ring bases 30.

A full rack 32 is arranged at the side part of the portal frame 20; the output shafts of the drive motors 31 are connected with the gears 33 meshed with the racks 32.

The output shafts of the drive motors 31 rotate clockwise or anticlockwise to drive the gears 33 to transmit on the racks 32 by control and signal conveying of the tire body drum drive unit 1 and the tire body drum drive unit 10. The drive motors 31 and the ring bases 30 drive the tire body transfer ring component 4 and the belted layer transfer ring 5 to slide in a reciprocating manner along the transverse direction of the portal frame 20 in common, so as to achieve material conveying between the stations of three drums.

A pair of slideways 36 is arranged at two sides of the portal frame 20. The ring bases 30 are connected to a pair of slide saddles 34, and slide blocks 35 arranged on the slide saddles 34 are meshed with the slideways 36.

The overall ring body does not deflect or swing by virtue of a sliding guide at two sides provided by the slideways 36 when the drive motors 31 drive the tire body transfer ring component 4 and the belted layer transfer ring 5 to transversely slide, so as to effectively reduce the sliding resistance.

A plurality of groups of adjusting frames 23 for adjusting the horizontal distances are arranged between the vertical directions of the truss 21 and the upright posts 22. The adjusting frames 23 are arranged in the slide chutes 24 at the tops of the upright posts 22. The wedge liner components 27, which are upwards screwed on the truss 21, are arranged on the adjusting frames 23, and arranged inside the fixation slot 28.

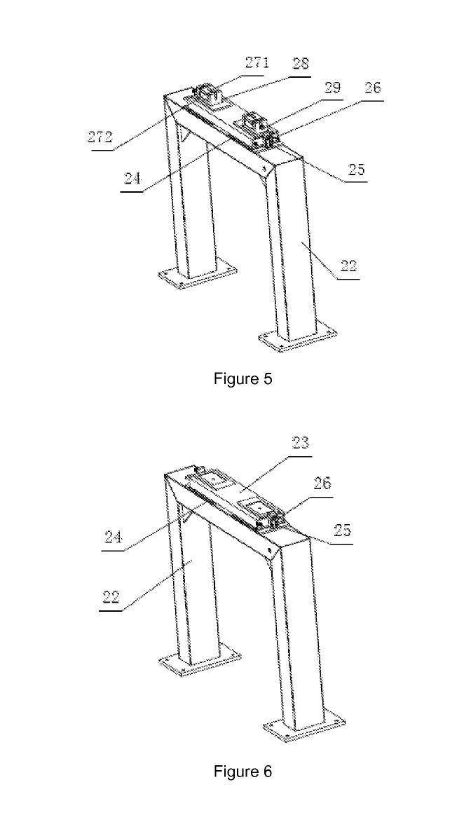

As shown in FIG. 5, the vertical brackets 25 are arranged on the upright posts 22, and inner thread holes are formed on the vertical brackets 25 and connected with the horizontal adjusting bolts 26. The horizontal adjusting bolts 26 are connected with the adjusting frames 23.

The horizontal adjusting bolts 26 can be rotated through a spanner under the premise of loosening lock bolts between the truss 21 and the upright posts 22. The horizontal adjusting bolts 26 rotate clockwise or anticlockwise inside the inner thread holes on the vertical brackets 25, so as to achieve longitudinal displacement (the longitudinal direction is the direction vertical to the axial center lines of the tire body drum 2, the belted layer drum 9 and the forming drum 7 in the FIGS. 2 and 3) of the truss 21 through the adjusting frames 23 and the wedge liner components 27. The transverse center line of the portal frame 20 is adjusted to overlap with the axial center lines of the tire body drum 2, the belted layer drum 9 and the forming drum 7.

As shown in FIG. 5, the wedge liner component 27 comprises the upper wedge liner 271 and a lower wedge liner 272, which are vertically laminated; the inner thread holes are arranged inside the fixation slot 28. The fixation slot 28 is connected with the vertical adjusting bolts 29; and the vertical adjusting bolts 29 are connected with the upper wedge liner 271 or the lower wedge liner 272.

The vertical adjusting bolts 29 can be rotated through the spanner, and rotate clockwise or anticlockwise inside the inner thread holes in the fixation slot 28, so as to achieve longitudinal displacement of the upper wedge liner 271 or the lower wedge liner 272.

Because the combined surface of the upper wedge liner 271 and the lower wedge liner 272 is an inclined plane, equivalently, the truss 21 is lifted upwards or reduced downwards when longitudinal displacement is generated between the upper wedge liner 271 and the lower wedge liner 272, so as to achieve adjustment of the truss 21 opposite to the vertical heights of the upright posts 22. Thus, the height of each end angle of the truss 21 is adjustable, and the vertical heights of the tire body transfer ring component 4 and the belted layer transfer ring 5 in the transverse sliding process can be kept consistent.

As shown in FIG. 3, the light ruler 37 is arranged at the side part of the portal frame 20 and above the tire body drum 2 and the belted layer drum 9, so that a light beam irradiates on the tire body drum 2 and the belted layer drum 9, so as to finish centering accuracy of the material attached to the drum in an assisting manner, and provide corresponding operation of visual ruler.

Based on use of the triple-drum forming machine for the tire, a novel material conveying method is achieved by the embodiment in the tire billet manufacturing processes as follows:

The tire bead for forming the tire, the tire body component and the belted layer-tread component are respectively prepared; the prepared tire body component and belted layer-tread component are respectively conveyed to the forming drum 7, so as to finish a manufacturing cycle of the overall technology.

The method flow for manufacturing the tire on the triple-drum forming machine for the tire comprises the following steps:

(1) Preparing the Tire Body Component:

The tire bead is placed at a preset position of the tire bead near the tire body drum by adopting a manual or mechanical device.

The tire body drum drive unit 1 drives the tire body drum 2 to rotate to the position demanded by the tire side technology through a servo motor, and carries out angle location.

The tire body drum 2 is continuously and linearly expanded, so that the diameter value achieves the technological requirements.

The tire body drum tailstock 3 is driven through a cylinder, and put into the position overlapping with the center line of the tire body drum 2. The tire body drum tailstock 3 supports the tire body drum 2.

The main feeding frame 13 conveys the precut tire side element to the tire body drum 2. The tire side element is adsorbed and fixed through a vacuum adsorption hole on the tire body drum 2, and rotates a cycle along with the tire body drum 2. The tire side element is laminated and jointed.

The tire body drum drive unit 1 drives the tire body drum 2 to rotate to the position demanded by the inside liner technology through the servo motor, and carries out angle location.

The main feeding frame 13 conveys the precut inside liner to the tire body drum 2. The inside liner is adsorbed and fixed through the vacuum adsorption hole on the tire body drum 2, and rotates a cycle along with the tire body drum 2. The inside liner is laminated and jointed.

The tire body drum drive unit 1 drives the tire body drum 2 to rotate to the position demanded by the bead fabric technology through the servo motor, and carries out angle location.

The main feeding frame 13 conveys the bead fabric to the tire body drum 2. The bead fabric is fixed and jointed, and rotates a cycle along with the tire body drum 2. The bead fabric is cut off and laminated and jointed, and the diameter of the tire body drum 2 expands a little.

The bead fabric is laminated by adopting a laminating device. The tire body drum drive unit 1 drives the tire body drum 2 to rotate to the position demanded by a tire body curtain technology through the servo motor, and carries out angle location.

The main feeding frame 13 conveys the cut-off tire body curtain to the tire body drum 2. The tire body curtain is fixed and jointed, and rotates a cycle along with the tire body drum 2. The tire body curtain is sewed and jointed, and the diameter of the tire body drum 2 expands a little again. A sizing material is laminated by adopting the laminating device, so as to ensure absence of air bubbles between the laminating layers.

The tire body drum drive unit 1 drives the tire body drum 2 to rotate to the position demanded by a pad rubber technology through the servo motor, and carries out angle location.

The pad rubber feeding frame 14 conveys the cut-off pad rubber to the tire body drum 2. The pad rubber is fixed and jointed, and rotates a cycle along with the tire body drum 2. The pad rubber is sewed and jointed.

The tire body drum tailstock 3 is driven by the cylinder to swing to the initial position.

(2) Conveying the Tire Body Component to the Forming Drum:

The tire body drum drive unit 1 and the tire body drum 2 are driven through the cylinder or the servo motor to move to the waiting position of the tire body transfer ring component 4 in a straight line.

The right steel rim clamping ring of the tire body transfer ring component 4 shrinks in a radial manner, and locates the right steel rim by adsorption of a magnet.

The steel rim at the left end of the tire body drum 2 is conveyed to the left steel rim clamping ring of the tire body transfer ring component 4.

The left steel rim clamping ring shrinks in a radial manner and locates the right steel rim by adsorption of the magnet. The tire body drum 2 is driven to carry out trace expansion in the radial manner for the third time, and achieves the position demanded by the technology. The tire body clamping ring of the tire body transfer ring component 4 shrinks in the radial manner, and adsorbs the tire body curtain by magnetism.

The tire body drum 2 rapidly shrinks, and returns to the initial position through the cylinder.

The tire side expansion ring of the tire body transfer ring component 4 carries out radial shrinkage and axial movement. The tire side expansion ring clamps the tire body barrel and carries out trace expansion in the radial manner.

The tire body transfer ring component 4 is driven through the servo motor to convey the tire body barrel to the forming drum 7. The forming drum tailstock 6 swings in the radial manner and supports the tail end of the forming drum 7.

A sector block of the forming drum 7 carries out radial expansion to locate the steel rim. All clamping rings of the tire body transfer ring component 4 expand in the radial manner, and the sector block of the forming drum 7 locks the steel rim.

The forming drum tailstock 6 comes away, and the tire body transfer ring component 4 returns to the initial waiting position.

(3) Preparing the Belted Layer-Tread Component:

The forming drum drive unit 10 drives the belted layer drum 9 to rotate to the laminating position demanded by the belted layer technology through the servo motor.

The belted layer feeding frame 12 conveys 1#, 2#, 3#, 4# or 0-degree belted layer to the belted layer drum 9, so as to laminate.

The tread feeding frame 11 conveys the tread to the belted layer drum 9 to laminate. The tread component is laminated by the tread roller of the belted layer feeding frame 12 after laminating.

(4) Conveying the Belted Layer-Tread Component to the Forming Drum:

The implementation steps of preparing and conveying the tire body component and the implementation steps of preparing and conveying the belted layer-tread component are simultaneously carried out step by step.

The belted layer transfer ring 5 is driven through the servo motor, so as to move to the position of the belted layer drum 9. The belted layer transfer ring 5 carries out radial shrinkage and clamps the tread component.

The belted layer drum 9 is driven through the cylinder and carries out rapid shrinkage in the radial manner. The belted layer transfer ring 5 conveys the tread component to the position of the forming drum 7.

(5) Finishing Tire Billet Manufacturing on the Forming Drum:

The forming drum drive unit 10 drives the sector block of the forming drum 7 to carry out axial shrinkage, and simultaneously aerates the sealed tire body barrel through the inner shaft of the forming drum 7. The sector block of the forming drum 7 is locked at the finalized position demanded by the tire technology and inner pressure is kept after the tire body barrel is completely combined with the tread component.

The belted layer transfer ring 5 moves to the waiting position, and the combined roller 8 is laminated to the tread and the tire side by drive of the servo motor.

The belted layer transfer ring 5 moves to the position of the forming drum 7 and clamps the formed tire billet and the tire billet is conveyed to the position of the tire unloading mechanism 15 after the combined roller 8 is completely laminated.

The tire unloading mechanism 15 shifts the formed tire billet of the external space of the triple-drum forming machine.

The tire body transfer ring component 4 transversely slides along the portal frame 20 to clamp and convey the tire body component to the forming drum 7 in the step (2).

The belted layer transfer ring 5 transversely slides along the portal frame 20 to convey the material of forming the belted layer-tread component to the belted layer drum 9 and prepare the tread component in the step (3).

The belted layer transfer ring 5 transversely slides to the belted layer drum 9 along the portal frame 20 and clamps and conveys the tread component to the forming drum 7 in the step (4).

The processes of preparing and conveying the tire body component to the forming drum in the steps (1) and (2) and the processes of preparing and conveying the belted layer-tread component to the forming drum in the steps (3) and (4) are simultaneously carried out.

The belted layer transfer ring 5 transversely slides to the forming drum 7 along the portal frame 20, so as to clamp the formed tire billet and convey the tire billet to the tire unloading mechanism 15 after the fixing and laminating operations of the tire body barrel and the tread component are finished on the forming drum 7 in the step (5).

Based on control of the method flow, the tire body transfer ring component 4 and the belted layer transfer ring 5 drive transmission between gears 33 and the racks 32 on the portal frame 20 by virtue of the drive motors 31, and transverse sliding of the tire body transfer ring component 4 and the belted layer transfer ring 5 along the portal frame 20 is achieved, so as to finish material conveying.

The tops of the tire body transfer ring component 4 and the belted layer transfer ring 5 provide a sliding guide through the slide saddles 34 of the slideways 36 at two sides of the portal frame 20 in the process of transversely sliding along the portal frame 20.

The adjusting frames 23 are driven to carry out longitudinal displacement through the horizontal adjusting bolts 26, so as to adjust the position of the transverse center line of the truss 21 between the truss 21 and the upright posts 22.

The upper wedge liners 271 and the lower wedge liners 272 are driven to carry out longitudinal displacement through the vertical adjusting bolts 29, so as to adjust the vertical height of each end point of the truss 21.

According to the present invention, therefore, a portal frame for conveying a dry material is arranged above the vertical directions of tire body drum, the belted layer drum and the forming drum. The transverse central line of the portal frame overlaps with the axial center lines of the tire body drum, the belted layer drum and the forming drum. The tops of the tire body transfer ring component and the belted layer transfer ring are respectively connected to the portal frame in a sliding manner. The portal frame further comprises a truss and a plurality of groups of upright posts, which are connected with each other; the truss is horizontally arranged, and the plurality of groups of upright posts are vertically arranged.

Accordingly, in preparing and conveying the tire body component and the belted layer-tread component, the portal frame provides a slide rail above the top. The tire body transfer ring component and the belted layer transfer ring can finish a material conveying operation, so as to clear related ground conveyers and to-be-paved pipelines.

Therefore, in the simultaneously carried out processes of preparing the tire body component and conveying the tire body component to the forming drum and the processes of preparing the belted layer-tread component and conveying the belted layer-tread component to the forming drum, the tire body transfer ring component and the belted layer transfer ring can transversely slide to a processing station along the portal frame. Material conveying is finished in the air, so that the material conveying is not affected by the ground device and the staff in the tire billet manufacturing process, and accidents caused by collision of the staff and equipment are effectively avoided.

In order to improve the maneuverability in the processes of conveying the tire body transfer ring component and the belted layer transfer ring in a sliding manner, a preferred embodiment includes ring bases respectively arranged at the tops of the tire body transfer ring component and the belted layer transfer ring. A drive motor, which is connected to or controlled by the tire body drive unit or the forming drum drive unit, is arranged on each ring base, and an output shaft of each drive motor is connected with a gear meshed with a rack on the portal frame. Transverse sliding of the tire body transfer ring component and the belted layer transfer ring along the portal frame is finished by the drive motor for driving transmission between the gear and the frame.

In order to prevent the tire body transfer ring component and the belted layer transfer ring from generating bouncing strength in the transverse sliding process and to improve the smoothness of the sliding process, slideways can be arranged at two sides of the portal frame. The ring bases of the portal frame are connected with a pair of slide saddles, and slide blocks arranged on the slide saddles are meshed with the slideways.

Thus, two sides of the top can provide sliding guide by virtue of the slideways to ensure that the overall ring body does not deflect or swing when the tire body transfer ring component and the belted layer transfer ring transversely slide, so as to effectively reduce the sliding resistance.

In order to further ensure that the transverse central line of the portal frame overlaps with the axial center lines of the tire body drum, the belted layer drum and the forming drum, or debugging and correcting can be carried out in deflection or misplacement, and a plurality of groups of adjusting frames for adjusting the horizontal distances can be arranged between the vertical directions of the truss and the upright posts of the portal frame. The adjusting frames are arranged inside the slide chutes at the tops of the upright posts, and are upwards connected with the truss. Vertical brackets are arranged on the upright posts. Inner thread holds are formed on the vertical brackets and connected with horizontal adjusting bolts, and the horizontal adjusting bolts are connected to the adjusting frames.

In order to ensure that the vertical heights of the tire body transfer ring component and the belted layer transfer ring in the transverse sliding process are kept consistent through the portal frame, wedge liner components, which are upwards screwed on the truss, are arranged on the adjusting frames and arranged into a fixation slot. Each wedge liner component comprises an upper wedge liner and a lower wedge liner, which are vertically laminated. Inner thread holes are formed in the fixation slot and connected with vertical adjusting bolts, and the vertical adjusting bolts are connected with each upper wedge liner or each lower wedge liner. The upper wedge liners and the lower wedge liners are driven to carry out longitudinal displacement through the vertical adjusting bolts, so as to adjust the vertical height of each end point of the truss.

In order to improve the centering accuracy of the material attached to the drum, and provide a corresponding operation of visual ruler, a light ruler can be arranged at the side part of the portal frame.

The present invention provides improvement of the triple-drum forming machine for the tire billet, and the material conveying method is simultaneously achieved from the design concept of the triple-drum forming machine. The tire bead for forming the tire, the tire body component and the belted layer-tread component are respectively prepared, and the prepared tire body component and belted layer-tread component are respectively conveyed to the forming drum, so as to finish a manufacturing cycle of the overall technology.

The method flow for manufacturing the tire on the triple-drum forming machine for the tire billet comprises the following steps:

(1) Preparing the tire body component;

(2) Conveying the tire body component to the forming drum;

(3) Preparing the belted layer-tread component;

(4) Conveying the belted layer-tread component to the forming drum;

(5) Finishing tire billet manufacturing on the forming drum.

Compared with the existing material conveying method of the triple-drum forming machine for the tire, the differences are as follows:

The portal frame, which is arranged above the vertical directions of tire body transfer ring component and the belted layer transfer ring provides a sliding conveying path along two sides of the axial center lines of the tire body drum, the belted layer drum and the forming drum.

The tire body transfer ring component transversely slides along the portal frame to clamp and convey the tire body component to the forming drum in the step (2).

The belted layer transfer ring transversely slides along the portal frame to convey the material for forming the belted layer-tread component to the belted layer drum and prepare the tread component in the step (3).

The belted layer transfer ring transversely slides to the belted layer drum along the portal frame, clamps the tread component and conveys to the forming drum in the step (4).

The processes of preparing the tire body component and conveying the tire body component to the forming drum in the steps (1) and (2) and the processes of preparing the belted layer-tread component and conveying to the belted layer-tread component to the forming drum in the steps (3) and (4) are simultaneously carried out.

The belted layer transfer ring transversely slides to the forming drum along the portal frame to clamp the formed tire billet and convey the tire billet to a tire unloading mechanism after the sizing and pressing operations of the tread component and a tire body barrel are finished on the forming drum in the step (5).

Accordingly, the present invention improves the sliding conveying maneuverability by providing that the tire body transfer ring component and the belted layer transfer ring drive transmission between the gear and the rack on the portal frame by virtue of the drive motor to achieve transverse sliding of the tire body transfer ring component and the belted layer transfer ring along the portal frame, so as to finish material conveying.

The present invention further improves the sliding conveying smoothness by providing that the tops of the tire body transfer ring component and the belted layer transfer ring provide sliding guide through the slide saddles meshed with the slideways at two sides of the portal frame in the process of transversely sliding along the portal frame.

In order to further ensure that the portal frame overlaps with the axial center lines of three drums, the tire body transfer ring component and the belted layer transfer ring, and a plurality of components are consistent in vertical height in the sliding process, the adjusting frames can be driven to carry out longitudinal displacement through the horizontal adjusting bolts, so as to adjust the position of the transverse center line of the truss between the vertical directions of the truss and the upright posts of the portal frame. The upper wedge liners and the lower wedge liners are driven to carry out longitudinal displacement through the vertical adjusting bolts, so as to adjust the vertical height of each end point of the truss.

The triple-drum forming machine for the tire and the material conveying method thereof have the following advantages.

1. The tire body transfer ring component and the belted layer transfer ring carry out sliding conveying along the portal frame, so as to finish air operation of all materials. Thus, the related ground conveyers can be effectively cleared, the occupation structure of the forming machine is simplified, and the construction operation of the operator is facilitated.

2. Accidents caused by collision of the operator and the ground equipment can be avoided, and field production is protected.

3. Pipeline pavement of the ground equipment can be simplified, and the overall installation, debugging and inspection of the forming machine by the operator are facilitated.

4. The accuracy of the conveying track of the tire body transfer ring component and the belted layer transfer ring can be improved, so as to effectively improve the tire billet manufacturing quality.

It will be apparent to those skilled in the art that various modifications can be made in the three drum tire-forming machine and material-conveying method of the present invention without departing from the spirit or scope of the invention. Thus, it is intended that the present invention covers the modifications and variations of this invention provided they come within the scope of the appended claims and their equivalents.

1. A triple-drum forming machine for a tire, comprising:
a tire body drum, a belted layer drum, and a forming drum each of which is arranged on the same horizontal axis, wherein the tire body drum is carried by a tire body drum drive unit, the belted layer drum and the forming drum are carried by a same forming drum drive unit;
a tire body transfer ring component for conveying a prepared tire body component to the forming drum arranged between the tire body drum and the forming drum; and
a belted layer transfer ring for conveying a prepared belted layer-tread component to the forming drum arranged between the tire body drum and the belted layer drum, wherein
a portal frame for conveying a dry material is arranged above the vertical directions of the tire body drum, the belted layer drum and the forming drum;
a transverse central line of the portal frame overlaps with the axial center lines of the tire body drum, the belted layer drum and the forming drum;
tops of the tire body transfer ring component and the belted layer transfer ring are respectively connected to the portal frame in a sliding manner; and
the portal frame comprises a horizontally arranged truss and a plurality of groups of vertically arranged upright posts; the horizontally arranged truss being connected with the vertically arranged upright posts.

2. The triple-drum forming machine for the tire according to the claim 1, wherein ring bases are respectively arranged at the tops of the tire body transfer ring component and the belted layer transfer ring;
a drive motor, which is connected to or controlled by the tire body drive unit or the forming drum drive unit is arranged on each ring base; and
an output shaft of each drive motor is connected with a gear meshed with a rack on the portal frame.

3. The triple-drum forming machine for the tire according to the claim 2, wherein slideways are arranged at two sides of the portal frame;
the ring bases are connected with a pair of slide saddles; and
slide blocks arranged on the slide saddles are meshed with the slideways.

4. The triple-drum forming machine for the tire according to the claim 1, further comprising:
a plurality of groups of adjusting frames for adjusting the horizontal distances between the truss and the upright posts being arranged between vertical directions of the truss and the upright posts wherein the adjusting frames are arranged inside slide chutes at the tops of the upright posts, and upwardly connected to the truss; and
vertical brackets arranged on the upright posts; wherein inner thread holds are formed on the vertical brackets and connected with horizontal adjusting bolts; the horizontal adjusting bolts being connected to the adjusting frames.

5. The triple-drum forming machine for the tire according to the claim 4, further comprising:
wedge liner components upwardly screwed on the truss are arranged on the adjusting frames into a fixation slot; wherein
each wedge liner component comprises an upper wedge liner and a lower wedge liner, which are vertically laminated;
inner thread holes are formed inside the fixation slot and connected with vertical adjusting bolts, the vertical adjusting bolts being connected with each upper wedge liner or each lower wedge liner.

6. The triple-drum forming machine for the tire according to the claim 5, further comprising a light ruler arranged at the side part of the portal frame.

7. A material conveying method achieved by the triple-drum forming machine for the tire according to claim 1, comprising:
arranging the portal frame above the vertical directions of the tire body transfer ring component and the belted layer transfer ring to provide a sliding conveying path along two sides of the axial center lines of the tire body drum, the belted layer drum and the forming drum;
transversely sliding the tire body transfer ring component along the portal frame to clamp and convey the tire body component to the forming drum in the process of conveying the tire body component to the forming drum;
transversely sliding the belted layer transfer ring along the portal frame to convey the material for forming the belted layer-tread component to the belted layer drum and prepare the tread component in the process of preparing the belted layer-tread component;
transversely sliding the belted layer transfer ring to the belted layer drum along the portal frame, clamping the tread component and conveying to the forming drum in the process of conveying the belted layer-tread component to the forming drum, wherein
preparing the tire body component and conveying the tire body component to the forming drum and preparing the belted layer-tread component and conveying to the belted layer-tread component to the forming drum are simultaneously carried out; and
transversely sliding the belted layer transfer ring to the forming drum along the portal frame (20) to clamp the formed tire billet and convey the tire billet to a tire unloading mechanism after the sizing and pressing operations of the tread component and a tire body barrel are finished on the forming drum) in the process of finishing tire billet manufacturing on the forming drum.

8. The material conveying method of the triple-drum forming machine for the tire according to claim 7, wherein the tire body transfer ring component and the belted layer transfer ring drive transmission between the gear and the rack on the portal frame by virtue of the drive motor to achieve transverse sliding of the tire body transfer ring component and the belted layer transfer ring along the portal frame (20), so as to finish material conveying.

9. The material conveying method of the triple-drum forming machine for the tire according to claim 8, wherein the tops of the tire body transfer ring component and the belted layer transfer ring provide sliding guide through the slide saddles meshed with the slideways at two sides of the portal frame in the transversely sliding along the portal frame.

10. The material conveying method of the triple-drum forming machine for the tire according to claim 7, wherein the adjusting frames are driven to carry out longitudinal displacement through the horizontal adjusting bolts, so as to adjust the position of the transverse center line of the truss) between the vertical directions of the truss) and the upright posts; and
the upper wedge liners and the lower wedge liners are driven to carry out longitudinal displacement through the vertical adjusting bolts, so as to adjust the vertical height of each end point of the truss.
